(19) United States
(12) Patent Application Publication
(10) Pub. No.: US 2018/0087906 A1
(43) Pub. Date: Mar. 29, 2018

(54) DEVICE ORIENTATION SYSTEMS AND METHODS

(71) Applicants: Alexander Kogan, Scarborough (CA); Edward Tan, Toronto (CA); Sean Huberman, Guelph (CA); Paramvir Singh Nagpal, Markham (CA)

(72) Inventors: Alexander Kogan, Scarborough (CA); Edward Tan, Toronto (CA); Sean Huberman, Guelph (CA); Paramvir Singh Nagpal, Markham (CA)

(73) Assignee: MAPSTED CORP., Markham (CA)

(21) Appl. No.: 15/713,370

(22) Filed: Sep. 22, 2017

Related U.S. Application Data
(60) Provisional application No. 62/495,875, filed on Sep. 28, 2016.

(51) Int. Cl. G01C 21/16; G01C 21/18

(52) U.S. Cl. CPC G01C 21/165; G01C 21/206; G01C 21/18

(57) ABSTRACT

Embodiments of the present disclosure relate to methods and systems of updating an orientation of a mobile device in a global reference frame. The method includes gathering mobile device gyroscope data, gathering mobile device accelerometer data, gathering mobile device magnetometer data, determining a first orientation of the mobile device based on the gyroscope data, determining a second orientation of the mobile device based on the device accelerometer data and the device magnetometer data, determining a trust factor associated with the second orientation, and updating the orientation of the mobile device based on the first orientation, the second orientation, and the trust factor.

### CROSS-REFERENCE TO RELATED APPLICATION

This application claims the benefit of U.S. Provisional Application No. 62/495,875, filed Sep. 28, 2016. Said U.S. Provisional Application No. 62/495,875 filed Sep. 28, 2016 is hereby incorporated in the entirety herein.

### BACKGROUND OF THE INVENTION

Users of mobile devices are increasingly using and depending upon indoor positioning and navigation applications and features. Seamless, accurate and dependable indoor positioning can be difficult to achieve using satellite-based navigation systems when the latter becomes unavailable or sporadically available, such as within enclosed or partly enclosed urban infrastructure and buildings, including hospitals, shopping malls, airports, universities and industrial warehouses. To address this problem, indoor navigation solutions increasingly rely on sensors including accelerometers, gyroscopes, and magnetometers which may be commonly included in mobile phones and other mobile devices. However, inertial navigation sensor-based solutions are often less than suitable due to error accumulation resulting from inherent susceptibility of the sensors to sensor draft and bias. Therefore, there exists a need for improved and efficient methods of determining mobile device orientation.

### BRIEF DESCRIPTION OF THE DRAWINGS

So that the manner in which the above recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram depicting a system according on which embodiments of the present disclosure may be implemented.

FIG. 2 is a flow diagram depicting the operation of a device orientation system, according to an embodiment.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE INVENTION

In the following description, multiple specific embodiment details are set forth to provide a more thorough understanding of the present disclosure. However, it will be apparent to one of skill in the art that the present disclosure may be practiced without one or more of these specific details.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are intended for purposes of illustration, and may not necessarily drawn to scale unless indicated as such.

Among other benefits and advantages, embodiments of the present disclosure relate to methods and systems of updating an orientation of a mobile device in a global reference frame. A method is provided wherein device sensor data is gathered, a first device orientation is determined based on the gyroscope data, a second device orientation is determined based on the accelerometer data and the magnetometer data, a trust factor for the second device orientation is determined, and an updated orientation of the mobile device is determined based on the first device orientation, the second device orientation, and the trust factor.

A system is also provided, including a memory, a processor, including software instructions stored in the memory, that, when executed by the processor, performs a method wherein device sensor data is gathered, a first device orientation is determined based on the gyroscope data, a second device orientation is determined based on the accelerometer data and the magnetometer data, a trust factor for the second device orientation is determined, and an updated orientation of the mobile device is determined based on the first device orientation, the second device orientation, and the trust factor.

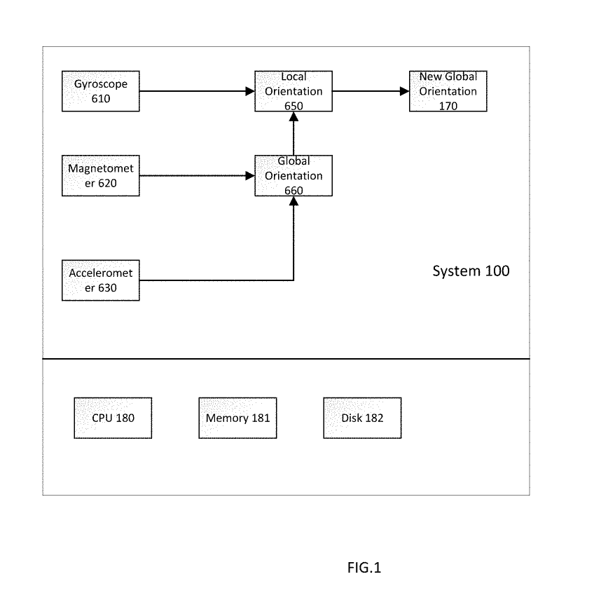

FIG. 1 depicts a block diagram of a system 100 on which embodiments of the present disclosure can be implemented. System 100 can be a mobile computing device such as a smartphone, a tablet, or any other computing platform comprising a CPU 180, random access memory 181, and a permanent memory storage 182.

Further provided are gyroscope 110, magnetometer 120, and accelerometer 130 (collectively referred to as components 110-130 herein). Components 110-130 can be implemented as hardware sensors built into the system 100, as software modules running on a hardware platform, or as standalone applications running on the hardware platform, or any combination thereof. Each of components 110-130 is configured to gather and receive their particular type of device data. For example, modules 110-130 can receive the data as a stream of analog-to-digital conversion ADC samples.

Local orientation module 150 is configured to receive as input raw gyroscope data from gyroscope 110. In one embodiment, gyroscope module 110 provides gyroscope data in terms of a delta or a change from a previous position in a sequence of positions. Local orientation module 150 can be configured to convert the rate of change of orientation to absolute change (expressed, for example, in angles or quaternions), for example by integrating the values over time using a Poisson integrator, or other suitable methods. The local coordinates may be expressed in local coordinate terms.

Global orientation module 160 is configured to receive as input raw magnetometer data from magnetometer 120 and raw accelerometer data from accelerometer 130, determine the orientation of the device with respect to a fixed global reference frame. The global orientation may be expressed in global coordinate terms, in an embodiment.

New global orientation module 170 is configured to receive as input the local orientation of the device 100 from local orientation module 150 and the global orientation of the device 100 from global orientation module 160. New global orientation module 170 is further configured, using software instructions stored in memory 101, in one embodiment, to compute a trust factor. The trust factor influences a relative weighting of the global orientation versus the local orientation in determining an updated or final orientation for mobile device 100.

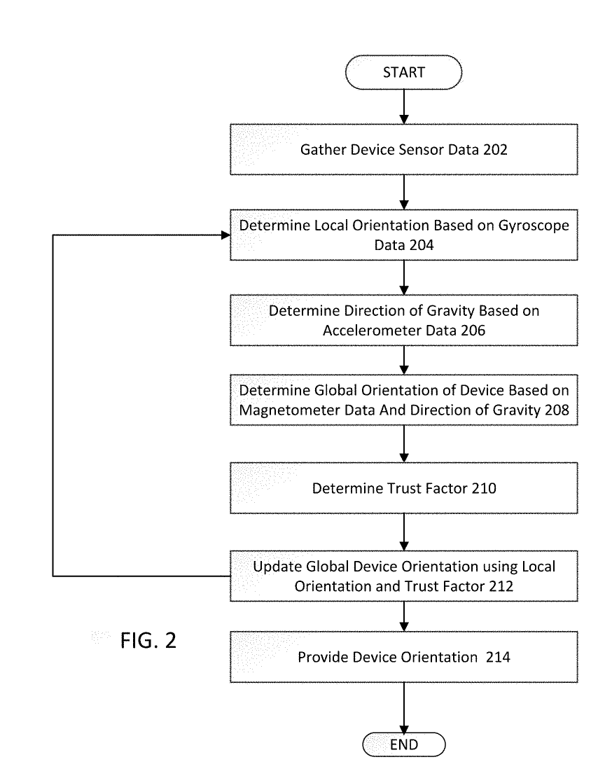

FIG. 2 depicts flow diagram 200 that describes the functioning of system 100 according to an embodiment. Flow diagram depicts a process wherein the device sensor data is converted to a global orientation for the mobile device or smartphone.

At step 202, device sensor and wireless signal strength data are gathered. For example, device sensor data can include accelerometer data, gyroscope data, magnetometer data, and any other sensor data available to the device such as barometric pressure data. In some embodiments, the accelerometer data and magnetometer data can be pre-processed using an adaptive infinite impulse response filter to smooth out the data and reduce noise. Due to the asynchronous operation of the different sensors—for example, because of differing sample rates, sampling times, or differing sensor implementations—inconsistencies in timing instances for the data collection may result. In the latter situation, it would be desirable to have the acquired sensor and signal data time-correlated, using time stamps in one for example embodiment, thereby identifying the particular time of acquisition of a given set of the sensor and signal data for any particular coordinate location. For any given location, therefore, the various sensor and signal data can then be matched, or time-correlated, in accordance with the time stamps, in one embodiment. Yet further, given that sampling periods and sampling rates applied in acquiring the sensor data may be different, the signal and sensor information as measured may be time-averaged across particular periods of time, with the time-averaged value being used to represent the signal information at any given instance of time within that particular period of time in which the signal information is time-averaged.

At 204, the local orientation is determined based on the gyroscope data gathered at step 202. The local orientation can be expressed as an orientation matrix or any other suitable data structure. In some embodiments, the local orientation is determined using a Poisson integrator. The Poisson Integrator can propagate an orientation matrix, Q, forward. For example, the orientation matrix Q can follow an equivalent Poisson kinematic equation: dQ/dt=QS, where S is a spinor matrix associated with angular vector ω. The solution to the kinematic equation is given by: Q(t+τ)=Q(t)R, where R=exp(τS) is orthogonal.

At step 206, the direction of gravity is determined based on the accelerometer data. For example, by measuring the amount of static acceleration due to gravity, the angle of tilt of the device with respect to the Earth can be determined.

At step 208, the global orientation of the device is determined based on the magnetometer data and the direction of gravity obtained using the accelerometer data at step 206. In one embodiment, global orientation module 160 can compensate for the magnetometer reading for a magnetic field in a particular geographic area due to the local bearing of the North magnetic pole. Global orientation module 160 can improve the accuracy of the azimuth (direction of north) by taking into account the specific curvature of the current geographic location and ensuring that the orientation matrix remains orthonormal and stable by dynamically combining the gathered accelerometer and magnetometer data with the local geographic bearing data.

At step 210, a trust factor for the orientation is determined. The trust factor be applied to weight the global orientation obtained from the accelerometer and magnetometer data relative to the local orientation obtained from the gyroscope data to determine a final orientation for the device. For example, the trust factor can indicate that the device 100 is located in a strong magnetic field. In one embodiment, the trust factor can be determined by measuring the magnetic field in a specific location and comparing it to an expected value of the magnetic field for that particular location. For example, if the magnetic field at a specific location has previously been determined to be “clockwise 45 degrees from magnetic north”, the trust factor can be high if the currently detected field is close to the previously measured value, and conversely, low if the currently detected field deviates significantly from the previously measured value. In other words, the trust factor can measure or quantify the degree of deviation from an expected value or measurement of the magnetic field, and not merely the presence of a magnetic perturbation.

In other embodiments, the trust factor can describe a signal to noise ratio or any other quantifiable measure of sensor devices drift and bias in regard to the global orientation. In some embodiments, the trust factor can be normalized to a value between 0 and 1.

In some embodiments, the trust factor for the orientation can be expressed as a variable of γ comprising two values, of γ(d), the trust factor relating to device sensor bias and of γ(e), the trust factor relating to environmental factors such as, for example, magnetic field perturbations according to the variation in measured versus expected magnetic field.

At step 212, the global device orientation is updated with the local device orientation determined at step 204 and the trust factor determined at step 210. For example, if trust factor is determined to be low, the new device orientation can be determined by applying a weighting primarily biased in favor of the global orientation based on accelerometer 130 and magnetometer 120. If the trust factor is determined to be high, then the new device orientation can be determined by applying the weighting biased in favor of the local orientation based on the gyroscope 110.

In another embodiment, the device orientation can be determined using a Rodrigues matrix filter. For example, the Rodrigues matrix filter can shift the global device orientation along a geodetic curve to accommodate for adjustments due to the curvature of the Earth at a given geographic location (a one-dimensional manifold of matrices of rotation around a fixed axis) connecting a predicted and measured rotation matrix. Specifically, the rotation matrix A is further rotated about the same axis by an angle of γ, which can be evaluated as: A^{γ}=exp(γln A), wherein γ is the trust factor as described above, A is the previous rotation matrix, and A_{γ} is the rotation matrix after applying the trust factor.

The disclosure has been described above with reference to specific embodiments. Various embodiments may be used in alone or in combination. Persons skilled in the art, however, will understand that various modifications and changes may be made thereto without departing from the broader spirit and scope of the disclosure as set forth in the appended claims. The foregoing description and drawings are, accordingly, to be regarded in an illustrative rather than a restrictive sense.

1. A method of updating an orientation of a mobile device, comprising:
gathering mobile device gyroscope data;
gathering mobile device accelerometer data;
gathering mobile device magnetometer data;
determining a first orientation of the mobile device based on the gyroscope data;
determining a second orientation of the mobile device based on the device accelerometer data and the device magnetometer data;
determining a trust factor for the second orientation; and
updating the orientation of the mobile device based on the first orientation, the second orientation, and the trust factor.

2. The method of claim 1 wherein the trust factor is determined at least in part based on the device magnetometer data.

3. The method of claim 2 wherein the trust factor is further determined at least in part based on a degree of deviation of the device magnetometer data from an expected value thereof.

4. The method of claim 1 wherein determining the first orientation comprises integrating the mobile device gyroscope data, and determining the orientation of the mobile device further comprises shifting the first device orientation along a geodetic curve based on a Rodrigues Matrix filter.

5. The method of claim 1 further comprising ensuring orthonormality of the updated orientation of the mobile device based on dynamically combining the gathered mobile device accelerometer and magnetometer data with local geographic bearing data.

6. The method of claim 1 wherein the first orientation is expressed in a set of local device coordinate terms.

7. The method of claim 1 wherein the second orientation is expressed in a set of global coordinate terms.

8. The method of claim 1 wherein the first orientation and the second orientation comprise a first and a second orientation matrix respectively.

9. The method of claim 1 wherein the mobile device gyroscope data, the mobile device accelerometer data, and the mobile device magnetometer data are time-correlated.

10. The method of claim 1, further comprising processing the mobile device accelerometer data and the mobile device magnetometer data using an infinite impulse response filter.

11. A system for updating an orientation of a mobile device, the system
comprising:
a processor;
a memory storing instructions, the instructions being executable in the processor to:
gather mobile device gyroscope data;
gather mobile device accelerometer data;
gather mobile device magnetometer data;
determine a first orientation of the mobile device based on the gyroscope data;
determine a second orientation of the mobile device based on the device accelerometer data and the device magnetometer data;
determine a trust factor for the second orientation; and
update the orientation of the mobile device based on the first orientation, the second orientation, and the trust factor.

12. The system of claim 11 wherein the trust factor is determined at least in part based on the device magnetometer data.

13. The system of claim 11 wherein the trust factor is further determined at least in part based on a degree of deviation of the device magnetometer data from an expected value thereof.

14. The system of claim 11 wherein determining the first orientation comprises integrating the mobile device gyroscope data, and determining the orientation of the mobile device further comprises shifting the first device orientation along a geodetic curve based on a Rodrigues Matrix filter.

15. The system of claim 11 further comprising ensuring orthonormality of the updated orientation of the mobile device based on dynamically combining the gathered mobile device accelerometer and magnetometer data with local geographic bearing data.

16. The system of claim 11 wherein the first device orientation is expressed in local device coordinate terms.

17. The system of claim 11 wherein the second device orientation is expressed in global coordinate terms.

18. The system of claim 11 wherein the first device orientation and the second device orientation each comprise an orientation matrix.

19. The system of claim 11 wherein the mobile device gyroscope data, the mobile device accelerometer data, and the mobile device magnetometer data are time-correlated.

20. The system of claim 11 wherein the device accelerometer data, and the device magnetometer data are further processed using an infinite impulse response filter.
